(19) United States
(12) Patent Application Publication
(10) Pub. No.: US 2018/0330675 A1
(43) Pub. Date: Nov. 15, 2018

(54) Display Device

(71) Applicant: Top Victory Investments Ltd., Kowloon (HK)

(72) Inventors: Li-Wei Lin, New Taipei City (TW); Chen-Chiang LEE, New Taipei City (TW); Yank-Chin HUNG, New Taipei City (TW); Hung-Yi CHEN, New Taipei City (TW); Chih-Yuan CHEN, New Taipei City (TW); Wen-Hsin HUNG, New Taipei City (TW)

(21) Appl. No.: 15/591,178

(22) Filed: May 10, 2017

(51) Int. Cl. G09G 3/36

(52) U.S. Cl. CPC G09G 3/36; G09G 2320/0693; G09G 2330/023; G09G 2310/08; G09G 2360/144; G09G 2320/043; G09G 2320/041

(57) ABSTRACT

A display device includes a display module, a control module, a power supply module, and a power monitoring module. The control module is signally connected to the display module. The power supply module is electrically connected to the control module. The power supply module includes an input terminal and an output terminal. The input terminal receives input electricity. The output terminal outputs output electricity to the control module. The power monitoring module is electrically connected to the power supply module and the control module. The power monitoring module monitors an output power of the output electricity and an input power of the input electricity and calculates a power loss ratio according to the output power and the input power. When the power loss ratio is less than a loss threshold, the power monitoring module generates a first notifying data according to the power loss ratio.

### FIELD OF THE INVENTION

The present invention relates to a display device and, more particularly, to a display device capable of sensing power and ambience. The display device includes, but is not limited to, a television or a computer monitor.

### BACKGROUND OF THE INVENTION

Whether in a modern family or in an office place, display devices are more or less one of the necessities. People are always around display devices in casual time or in working hours. Conventional display devices can only receive signals to display images or play TV programs. Recently, a kind of smart display device is commercially available, which is built in with a network module, an operation system, and an application(s). That is to say, the display device provides both of a multimedia function and a web surfing function, like a small computer. However, either the conventional display device or the smart display device is incapable of monitoring their own power loss state and surrounding environment state. The display device cannot interact with peripheral equipment. Users cannot obtain information about states of internal components of a TV to check if there is any aging component negatively influencing power loss and also cannot obtain environment state through the TV.

In addition, a conventional display device usually operates individually. There is no any interactive mechanism between the display device and peripheral equipment, which is hard to build a smart family system well.

### SUMMARY OF THE INVENTION

Conventional display devices lack a function that can monitor their own power loss state and surrounding environment state. Display devices are cores to people whether in the living or the work; however, display devices cannot provide more information to allow people to determine the state of a display device and to know the state of the environment in time. Obviously, there are drawbacks of conventional display devices. To address the above issue, the present invention provides a display device, which can not only monitor its own power loss state and surrounding environment state, but also provide information to users or security system. In addition, the display device can further control related equipment automatically.

According to an embodiment of the present invention, a display device comprises a display module, a control module, a power supply module, and a power monitoring module. The control module is signally connected to the display module. The power supply module is electrically connected to the control module. The power supply module comprises an input terminal and an output terminal. The input terminal receives input electricity. The output terminal outputs output electricity to the control module. The power monitoring module is electrically connected to the power supply module and the control module. The power monitoring module monitors an output power of the output electricity and an input power of the input electricity and calculates a power loss ratio according to the output power and the input power. When the power loss ratio is less than a loss threshold, the power monitoring module generates a first notifying data according to the power loss ratio.

In an embodiment of the present invention, the display device further comprises a network module. The network module is signally connected to the power monitoring module. The first notifying data is transmitted to a cloud server or a portable device through the network module.

In an embodiment of the present invention, the power monitoring module is further signally connected to the control module. When the power loss ratio is less than the loss threshold, the control module controls the power supply module to lower the output power of the output electricity.

In an embodiment of the present invention, the display device further comprises an ambience monitoring module. The ambience monitoring module is signally connected to the control module. The ambience monitoring module monitors an internal environment or an external environment of the display device and correspondingly generates at least one numerical data.

In an embodiment of the present invention, the ambience monitoring module comprises a temperature humidity sensing unit. The temperature humidity sensing unit monitors the internal environment of the display device and correspondingly generates a temperature value and a humidity value. When the power loss ratio is less than the loss threshold, the power monitoring module generates the first notifying data according to the power loss ratio, the temperature value, and the humidity value.

In an embodiment of the present invention, the ambience monitoring module comprises an ultraviolet (UV) sensing unit and a timing unit. The UV sensing unit monitors an intensity of UV of the external environment of the display device and correspondingly generates a UV intensity value, and the timing unit correspondingly counts time and generates an accumulated time value.

In an embodiment of the present invention, when the UV intensity value is greater than a UV intensity threshold, the timing unit correspondingly counts time and generates the accumulated time value. The accumulated time value is a continuous time during which the UV intensity value is greater than the UV intensity threshold.

In an embodiment of the present invention, the ambience monitoring module comprises an ambience light sensing unit. The ambience light sensing unit monitors a light intensity of the external environment of the display device and correspondingly generates a light intensity value. When the light intensity value is greater than a light intensity threshold, the ambience monitoring module generates a second notifying data; when the light intensity value is less than the light intensity threshold, the ambience monitoring module generates a third notifying data.

In an embodiment of the present invention, the ambience monitoring module comprises a gas sensing unit or a pressure sensing unit. The gas sensing unit monitors a carbon monoxide concentration value or a particulate matter concentration value of the external environment of the display device. The pressure sensing unit monitors a pressure value of the external environment of the display device. When the carbon monoxide concentration value is greater than a carbon monoxide concentration threshold or the particulate matter concentration value is greater than a particulate matter concentration threshold, the ambience monitoring module generates a fourth notifying data; when the pressure value is less than a pressure threshold, the ambience monitoring module generates a fifth notifying data.

In an embodiment of the present invention, the ambience monitoring module comprises an acceleration sensing unit. The acceleration sensing unit monitors an acceleration value of the display device. When the acceleration value is greater than an acceleration threshold, the ambience monitoring module generates a sixth notifying data, and the control module turns off the power supply module when the control module receives the sixth notifying data.

Concisely, the display device disclosed according to embodiments of the present invention can not only monitor its own power loss state and surrounding environment state, but can also provide information or perform automatic control. In such case, users can obtain the state of the display device in time so as to timely fix aging components or adjust the power consuming condition to save power. In addition, users can be informed of the state of the surrounding environment in time so as to timely adjust related equipment or make appropriate responses. According the invention, life can be more convenient, and users can take care of their healthy well.

The features of the present invention will no doubt become understandable to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a display device according to an embodiment of the present invention;

FIG. 2 illustrates a block diagram of a display device according to another embodiment of the present invention; and

FIG. 3 illustrates a schematic diagram of the use of a display device according to another embodiment of the present invention.

### DETAILED DESCRIPTION OF ILLUSTRATIVE EMBODIMENTS

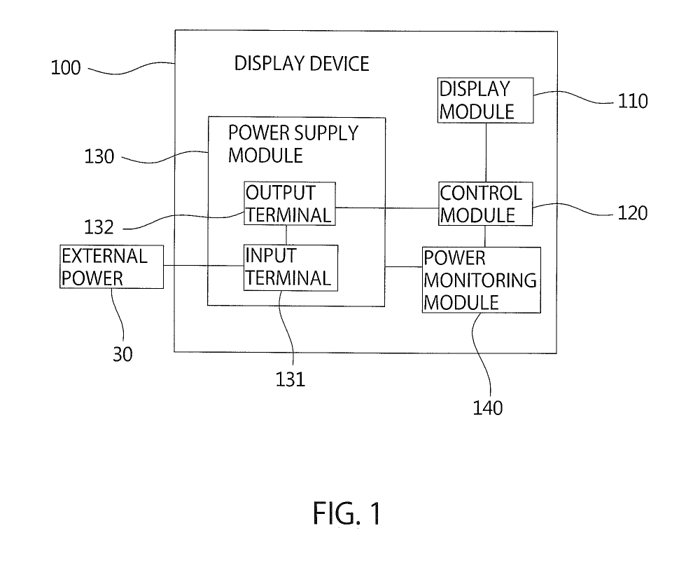

Please refer to FIG. 1. FIG. 1 illustrates a block diagram of a display device 100 according to an embodiment of the present invention. In the embodiment, the display device 100 is, but is not limited to, a smart TV. The display device 100 comprises a display module 110, a control module 120, a power supply module 130, and a power monitoring module 140. The display module 110 is a liquid crystal display module, which includes a liquid crystal panel and a backlight module. The control module 120 is signally connected to the display module 100. The control module 120 is capable of transmitting control signals to the display module 110 so that the display module 110 can generate images. The power supply module 130 is electrically connected to the control module 120 in order to transmit electricity to the control module 120 and further allow the display module 110 to generate images. The power supply module 130 comprises an input terminal 131 and an output terminal 132. The input terminal 131 can receive an input electricity. The output terminal can output an output electricity to the control module 120. The input electricity can be connected to an external power supply 30 through wires. The external power supply 30 is, for example, an electricity grid connected through a receptacle.

The power monitoring module 140 is electrically connected to the power supply module 130. The power monitoring module 140 monitors an output power of the output electricity and an input power of the input electricity and calculates a power loss ratio according to the output power and the input power. During the operation of the display device 100, the power monitoring module 140 continuously monitors voltages and currents of the input electricity inputted from the input terminal 131, and the power monitoring module 140 calculates the input power according to the voltages and currents of the input electricity. In addition, the power monitoring module 140 continuously monitors voltages and currents of the output electricity outputted from the output terminal 132, and the power monitoring module 140 calculates the output power according to the voltages and currents of the output electricity. The output electricity is transmitted to the control module 120 and further transmitted to components needing to consume power, such as the liquid crystal panel, the backlight module, control circuits, and speakers.

Therefore, there may be two or more output power generated in the same time. Herein, the output power means a sum of all of the output power. The power loss ratio is a percentage of the output power divided by the input power. The power loss ratio also represents the efficiency of power conversion. The lower the value of the power loss ratio is, the poor the efficiency is. In such case, it also represents that more power will be consumed, which may mean that internal components are too old or aging components are too many. In some cases, this situation possibly means that the internal components may have issues that need to be inspected or adjusted.

In general, the power loss ratio being about 80% is acceptable. Therefore, a loss threshold, as a parameter, can be set and saved in the power monitoring module 140 or the control module 120. The loss threshold can be 80%. During the operation of the display device 100, the power monitoring module 140 continuously calculates the power loss ratio to monitor the self-state of the display device 100. If the power loss ratio is greater than or equal to the loss threshold, the display device 100 is in a good state. However, when the power loss ratio is less than the loss threshold, the power monitoring module 140 generates a first notifying data according to the power loss ratio. The first notifying data may be transmitted to the control module 120, and the control module 120 may automatically lower load and then process detection again. In addition, the control module 120 may control the power supply module 130 to lower the output power of the output electricity and lower the load of certain unnecessary component in response to the state that the efficiency of power conversion becomes worse, so as to save the electricity.

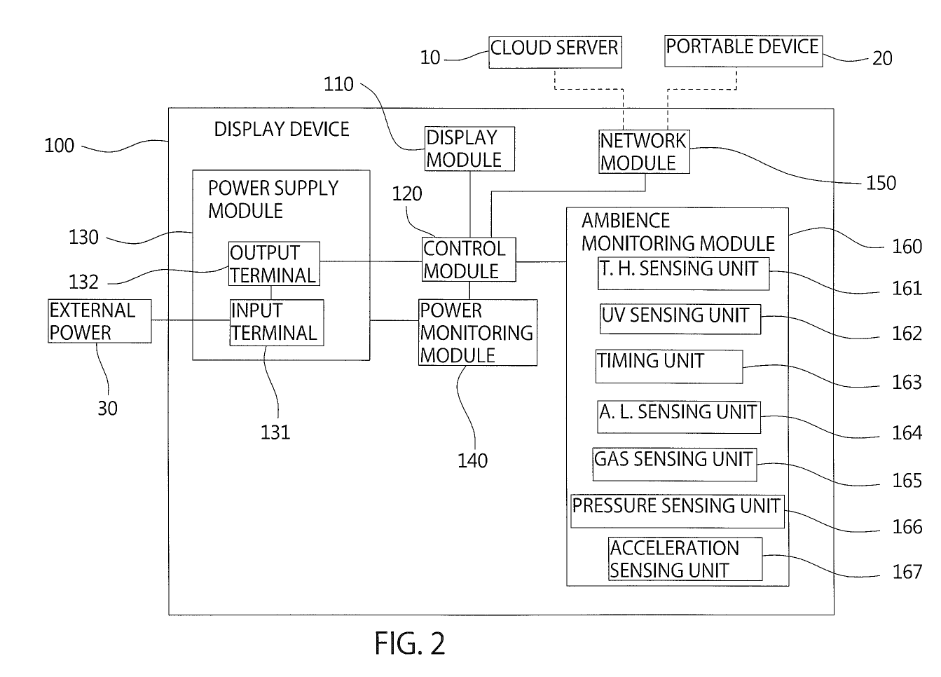

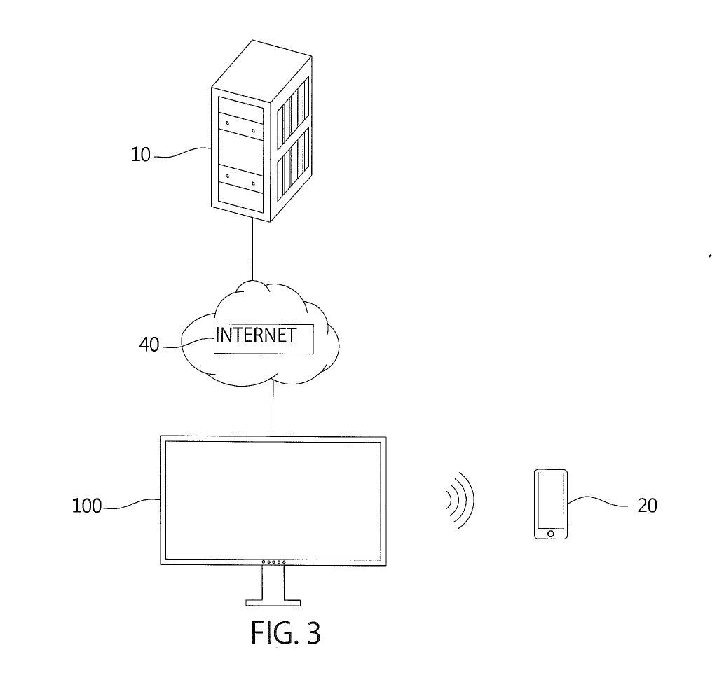

Please refer to FIG. 2 and FIG. 3. FIG. 2 illustrates a block diagram of the display device 100 according to another embodiment of the present invention. FIG. 3 illustrates a schematic diagram of the use of the display device 100 according to another embodiment of the present invention. In the embodiment, the display device 100 further comprises a network module 150. The network module 150 is signally connected to the control module 120 and the power monitoring module 140. The network module 150 may be connected to a cloud server 10 and a portable device 20 in a wire or wireless manner. As shown in FIG. 3, the network module 150 may be connected to the cloud server 10 through internet 40 and connected to the portable device 20 through a wireless network. Wherein, the portable device 20 may be, but not limited to, a smart cell phone or a tablet computer. In the embodiment, the first notifying data generated by the power monitoring module 140 is not only transmitted to the control module 140, but is also transmitted to the cloud server 10 or the portable device 20 through the network module 150. For example, the first notifying data may be transmitted to a smart phone of a user through a wireless access point near the display device 100, so that the user can be aware of the state of the display device 100 (e.g., the user can be notified that the current power loss ratio of the display device 100 is less than 80%). And the first notifying data may be transmitted to the cloud server 10 through the internet 40, so that the manufacturer of the display device 100 can be aware of the situation and can make and track statistics regarding relative information. These statistics and information can facilitate maintaining services and can be bases to improve the design of display devices of new generation.

In the embodiment, the display device 100 further comprises an ambience monitoring module 160. The ambience monitoring module 160 is signally connected to the control module 120. The ambience monitoring module 160 monitors an internal environment or an external environment of the display device 100 and correspondingly generates at least one numerical data. The internal environment is, for example, the state of an internal environment inside the housing of the display device 100. The external environment is, for example, the state of an indoor environment at which the display device 100 is placed. The numerical data is, for example, relevant numerical value(s) sensed by certain sensor(s).

In the embodiment, the ambience monitoring module 160 comprises a temperature humidity sensing unit 161. The temperature humidity sensing unit 161 may monitor the internal environment of the display device 100 and correspondingly generates a temperature value and a humidity value. The temperature value and the humidity value are numerical values sensed inside the housing of the display device 100. In general, electric components operated under a condition of high temperature and high humidity may age or be damaged sooner. Therefore, parameters of the temperature and the humidity can be auxiliary factors to determine the self-state of the display device 100. When the power loss ratio is less than the loss threshold, the power monitoring module 140 generates the first notifying data according to the power loss ratio, the temperature value, and the humidity value. In other word, the first notifying data includes not only the power loss ratio but also the temperature value and the humidity value. As a result, users and manufacturers can obtain more information, and thus it is more effective to determine how to improve the state of aging of the display device 100 to avoid early damage.

In some embodiments, the display device 100 can be signally connected to an air conditioner or a dehumidifier through the network module 150, so as to transmit the first notifying data with control signals to the air conditioner or the dehumidifier. In such case, when the temperature and the humidity are too high, the display device 100 can have the air conditioner or the dehumidifier automatically turned on to lower the indoor temperature and the humidity.

In the embodiment, the ambience monitoring module 160 comprises a UV sensing unit 162 and a timing unit 163. The UV sensing unit 162 monitors an intensity of UV of the external environment of the display device 100 and correspondingly generates a UV intensity value, and the timing unit 163 correspondingly counts time and generates an accumulated time value. UV rays are everywhere. Even in an indoor environment, lots of UV rays can penetrate through windows with curtain drawn apart and cause damages to the user's skin and eyes. When the user uses the display device 100, the UV sensing unit 162 senses the UV intensity value of the indoor environment at which the display device 100 is placed. When the UV intensity value is greater than a UV intensity threshold, the display device 100 displays a message on a screen or transmits the message to the smart cell phone of the user through the network module 150 to remind the user that the UV intensity value of the environment at the moment is too high, so that the user can be alerted to draw the curtain on or put some sunscreen on the skin. In addition, when a user turns on the display device 100, the UV sensing unit 162 is not the only one being start to operate. Particularly, the timing unit 163 also starts to correspondingly counts time to calculate and generate the accumulated time value, which represents a continuous operating time of the display device 100. Under the circumstances that the accumulated time value is greater certain threshold, the display device 100 displays a message on a screen or transmits the message to the smart cell phone of the user through the network module 150 to remind the user that currently he or she has watched the display device 100 over a particular time, and it's about time to have his or her eyes rest to avoid possible injury to eyes.

In some embodiments, the timing unit 163 starts to correspondingly counts time to generate the accumulated time value only when the UV intensity value is greater than the UV intensity threshold. In other words, the accumulated time value herein represents a continuous time during which the UV intensity value is greater than the UV intensity threshold. In such case, users can be aware of risks that he or she has been exposed to high intensity UV rays too long.

In the embodiment, the ambience monitoring module 160 further comprises an ambience light sensing unit 164. The ambience light sensing unit 164 monitors a light intensity of the external environment of the display device 100 and correspondingly generates a light intensity value. The light intensity value is intensity of ambience light of an environment at which the display device 100 is placed, including indoor illumination intensity or indoor sun intensity of sun rays shining the indoor environment from outside at daylight. When the light intensity value is greater than a light intensity threshold, it means the intensity of ambience light being too high, and the ambience monitoring module 160 generates a second notifying data, which may suggest users to increase brightness of the display device 100 to optimize the effect for watching. When the light intensity value is less than the light intensity threshold, it means the intensity of ambience light being too low, and the ambience monitoring module 160 generates a third notifying data, which may suggest users to decrease brightness of the display device 100 to reduce stimulations to eyes caused by high intensity light rays.

In some embodiments, the display device 100 can be signally connected to indoor illumination equipment through the network module 150 so as to transmit the second notifying data or the third notifying data with control signals to the indoor illumination equipment. In such case, the display device 100 can have the indoor illumination equipment adjust the brightness of indoor illumination accord to the intensity of indoor ambience light.

In the embodiment, the ambience monitoring module 160 comprises a gas sensing unit 165 or a pressure sensing unit 166. The gas sensing unit 165 monitors a carbon monoxide concentration value or a particulate matter (PM 2.5) concentration value of the external environment of the display device 100. The pressure sensing unit 166 monitors a pressure value of the external environment of the display device 100. When the carbon monoxide concentration value is greater than a carbon monoxide concentration threshold or the particulate matter concentration value is greater than a particulate matter concentration threshold, the ambience monitoring module 160 generates a fourth notifying data to warn users that currently indoor air may have some problems. Under the circumstances that the carbon monoxide concentration value is too high, users shall be notified to leave the spot as soon as possible. Under the circumstances that the particulate matter concentration value is too high, users shall be notified to wear a breathing mask or turn on an air purifier to pure indoor air.

In some embodiments, the display device 100 can be signally connected to a community security system through the network module 150 so as to transmit the fourth notifying data with alert information to the security system. In such case, a security company or a community guard can be notified that the carbon monoxide concentration value in certain house of certain household is too high so that the security company or the community guard can deals with the situation in time. In some embodiments, the display device 100 can be signally connected to an indoor air purifier through the network module 150 so as to transmit the fourth notifying data with control signals to the air purifier to have the air purifier turned on automatically. When the pressure value is less than a pressure threshold, and, specifically, when the pressure sensing unit 166 discovers a phenomenon that the pressure has dropped in a short time, the ambience monitoring module 160 generates a fifth notifying data to notify users that a rain may be coming.

In the embodiment of the present invention, the ambience monitoring module 160 comprises an acceleration sensing unit 167. The acceleration sensing unit 167 monitors an acceleration value of the display device 100. Generally, the acceleration value of the display device 100 should be 0. However, under special circumstances, e.g., an earthquake occurring or the displace device 100 being accidentally collided, the displace device 100 would generate an acceleration. In such case, the display device 100 would automatically respond to the acceleration value in time to avoid any dangerous conditions such as short circuits of internal components or fire caused by the falling of the display device 100 during operation due to swaying or being collided. For example, when the acceleration value is greater than an acceleration threshold, it means the display device 100 suffers from a great shocking or colliding and has highly risk to falling; therefore, the ambience monitoring module 160 would generate a sixth notifying data, and the control module 120 would turn off the power supply module 130 to have the display device 100 stopped (been disable) when the control module 120 receives the sixth notifying data. The risk of short circuits of internal components or fire caused by the falling of the display device 100 can be lowered. In addition, when the control module 120 receives the sixth notifying data, the display device 100 may sound an alarm in advance or may transmit signals to the security system to have the security system sound the alarm to notify users that there may be an accident at the moment.

Concisely, the display device disclosed according to embodiments of the present invention can not only monitor its own power loss state and surrounding environment state, but can also provide information to users such that users can be informed of the state of the display device in time so as to timely fix aging components or adjust power consuming condition to save power; alternatively, the display device can provide information to a security system to sound an alarm. In addition, the display device can perform automatic control to related equipment. Consequently, a better smart family system is built.

According to the display device of the embodiments of the present invention, users can not only be informed of the state of the surrounding environment in time so as to timely adjust related equipment or make appropriate responses to make life more convenient, but can also take care of their healthy well.

While the present invention has been described by way of example and in terms of the preferred embodiments, it is to be understood that the present invention needs not be limited to the disclosed embodiments. For anyone skilled in the art, various modifications and improvements within the spirit of the present invention are covered under the scope of the present invention. The covered scope of the present invention is based on the appended claims.

What is claimed is:

1. A display device, comprising:
a display module;
a control module signally connected to the display module;
a power supply module electrically connected to the control module, the power supply module comprising an input terminal and an output terminal, the input terminal receiving an input electricity, the output terminal outputting an output electricity to the control module; and
a power monitoring module electrically connected to the power supply module and the control module, the power monitoring module monitoring an output power of the output electricity and an input power of the input electricity and calculating a power loss ratio according to the output power and the input power, wherein when the power loss ratio is less than a loss threshold, the power monitoring module generates a first notifying data according to the power loss ratio.

2. The display device of claim 1, further comprising a network module, the network module being signally connected to the power monitoring module, wherein the first notifying data is transmitted to a cloud server or a portable device through the network module.

3. The display device of claim 1, wherein the power monitoring module is further signally connected to the control module, and when the power loss ratio is less than the loss threshold, the control module controls the power supply module to lower the output power of the output electricity.

4. The display device of claim 1, further comprising an ambience monitoring module, the ambience monitoring module being signally connected to the control module, wherein the ambience monitoring module monitors an internal environment or an external environment of the display device and correspondingly generates at least one numerical data.

5. The display device of claim 4, wherein the ambience monitoring module comprises a temperature humidity sensing unit, the temperature humidity sensing unit monitors the internal environment of the display device and correspondingly generates a temperature value and a humidity value, and when the power loss ratio is less than the loss threshold, the power monitoring module generates the first notifying data according to the power loss ratio, the temperature value, and the humidity value.

6. The display device of claim 4, wherein the ambience monitoring module comprises an ultraviolet (UV) sensing unit and a timing unit, the UV sensing unit monitors an intensity of UV of the external environment of the display device and correspondingly generates a UV intensity value, and the timing unit correspondingly counts time and generates an accumulated time value.

7. The display device of claim 6, wherein when the UV intensity value is greater than a UV intensity threshold, the timing unit correspondingly counts time and generates the accumulated time value, and the accumulated time value is a continuous time during which the UV intensity value is greater than the UV intensity threshold.

8. The display device of claim 4, wherein the ambience monitoring module comprises an ambience light sensing unit, the ambience light sensing unit monitors a light intensity of the external environment of the display device and correspondingly generates a light intensity value, and when the light intensity value is greater than a light intensity threshold, the ambience monitoring module generates a second notifying data; when the light intensity value is less than the light intensity threshold, the ambience monitoring module generates a third notifying data.

9. The display device of claim 4, wherein the ambience monitoring module comprises a gas sensing unit or a pressure sensing unit, the gas sensing unit monitors a carbon monoxide concentration value or a particulate matter concentration value of the external environment of the display device, the pressure sensing unit monitors a pressure value of the external environment of the display device, and when the carbon monoxide concentration value is greater than a carbon monoxide concentration threshold or the particulate matter concentration value is greater than a particulate matter concentration threshold, the ambience monitoring module generates a fourth notifying data; when the pressure value is less than a pressure threshold, the ambience monitoring module generates a fifth notifying data.

10. The display device of claim 4, wherein the ambience monitoring module comprises an acceleration sensing unit, the acceleration sensing unit monitors an acceleration value of the display device, and when the acceleration value is greater than an acceleration threshold, the ambience monitoring module generates a sixth notifying data, and the control module turns off the power supply module when the control module receives the sixth notifying data.
